(19) United States
(12) Patent Application Publication
(10) Pub. No.: US 2025/0385302 A1
(43) Pub. Date: Dec. 18, 2025

(54) SOLID-STATE BATTERY AND METHOD OF MANUFACTURING SOLID-STATE BATTERY

(71) Applicant: TOYOTA JIDOSHA KABUSHIKI KAISHA, Aichi-ken (JP)

(72) Inventors: Masashi CHIHARA, Nagoya-Shi (JP); Takahiro TABUCHI, Toyota-shi (JP); Yuka YOKOI, Nagoya-shi (JP)

(21) Appl. No.: 19/224,901

(22) Filed: Jun. 2, 2025

(30) Foreign Application Priority Data
Jun. 18, 2024 (JP) 2024-098200

(51) Int. Cl. H01M 10/0562; H01M 4/80

(52) U.S. Cl. CPC H01M 10/0562; H01M 4/806

(57) ABSTRACT

A solid-state battery of the present disclosure includes an electrode body, current collector tabs that are connected to the electrode body, and a protective member. The electrode body has a positive electrode current collector, a positive electrode active material layer, a solid electrolyte layer, a negative electrode active material layer, and a negative electrode current collector that are laminated along a lamination direction. The solid electrolyte layer has a support including a plurality of fibers that are different in material from the protective member. The support projects from an end surface of the solid electrolyte layer. The protective member is connected to the support and disposed at the end surface.

### CROSS-REFERENCE TO RELATED APPLICATION

This application is based on and claims priority under 35 USC 119 from Japanese Patent Application No. 2024-098200 filed on Jun. 18, 2024, the disclosure of which is incorporated by reference herein.

### BACKGROUND

### Technical Field

The present disclosure relates to a solid-state battery and a method of manufacturing the solid-state battery.

### Related Art

Solid-state batteries are known as lithium-ion secondary batteries that excel in safety.

Japanese Patent Application Laid-open (JP-A) No. 2024-11688 discloses an all-solid-state battery (hereinafter also called “the solid-state battery”). The solid-state battery has an electrode body and current collector tabs that are connected to the electrode body. The electrode body has a first current collector, a first active material layer, a solid electrolyte layer, a second active material layer, and a second current collector. The electrode body has a first side surface portion, a second side surface portion that opposes the first side surface portion, and a third side surface portion that interjoins the first side surface portion and the second side surface portion. At the first side surface portion, the first active material layer, the solid electrolyte layer, and the second active material layer are flush. A protective member is disposed on the first side surface portion. The protective member covers a side surface of at least one of the first active material layer, the solid electrolyte layer, or the second active material layer. At the third side surface portion, the first active material layer, the solid electrolyte layer, and the second active material layer are flush. A specific lashing member is disposed on the third side surface portion. The lashing member covers a side surface of at least one of the first active material layer, the solid electrolyte layer, or the second active material layer. Resin is disclosed as a material of the protective member and the lashing member.

However, in the solid-state battery disclosed in JP-A No. 2024-11688, a material of the protective member and the lashing member and a materials of the electrode body are different kinds. In other words, the coefficient of thermal expansion of the protective member and the lashing member and the coefficient of thermal expansion of the electrode body are different.

For that reason, when the solid-state battery is repeatedly charged and discharged, the adhesion of the protective member and the lashing member to the electrode body may weaken. If at least one of the protective member or the lashing member peels away from the electrode body, a short circuit between the positive electrode and the negative electrode of the electrode body may occur.

### SUMMARY

The present disclosure is in view of the above circumstances.

It is a problem to be solved by an embodiment of the present disclosure to provide a solid-state battery in which the occurrence of short circuits is inhibited and a method of manufacturing the solid-state battery.

Means for solving the above problem include the following aspects.
<1> A solid-state battery of a first aspect includes an electrode body, current collector tabs that are connected to the electrode body, and a protective member, wherein:
the electrode body has a positive electrode current collector, a positive electrode active material layer, a solid electrolyte layer, a negative electrode active material layer, and a negative electrode current collector that are laminated along a lamination direction,
the solid electrolyte layer has a support including a plurality of fibers that are different in material from the protective member,
the support projects from an end surface of the solid electrolyte layer, and
the protective member is connected to the support and disposed at the end surface.

“Solid electrolyte layer” refers to a layer that includes a solid electrolyte but does not include an active material (i.e., at least one of a positive electrode active material or a negative electrode active material). “Positive electrode active material layer” refers to a layer that includes a positive electrode active material. “Negative electrode active material layer” refers to a layer that includes a negative electrode active material. “Support” refers to an insulator that has a plurality of pores, imparts mechanical strength to the solid electrolyte layer, and does not conduct electricity. “Pores in the support” refers to holes that have the solid electrolyte disposed inside them and hold the solid electrolyte. The part of the support that projects from the end surface of the solid electrolyte layer may be a fiber assembly or single fibers (hereinafter also called “projecting fibers”). The fiber assembly may, for example, be part of a nonwoven or a mesh sheet. “Projecting fibers” refers to fibers that project relative to the end surface of the solid electrolyte layer and whose total length from the end surface of the solid electrolyte layer is 0.5 mm or less. The number of the projecting fibers that project from the end surface of the solid electrolyte layer is at least one but is preferably plural from the standpoint of inhibiting the occurrence of short circuits in the solid-state battery. “Protective member” refers to an insulator that is in a solid state at the operating temperature of the solid-state battery (e.g., 120° C. or lower) and does not conduct electricity. The laminate structure of the “electrode body” includes a monopolar structure or a bipolar structure.

In the first aspect, the protective member is connected to the support and disposed at the end surface of the solid electrolyte layer. Because of this, the area in which the protective member contacts the electrode body is larger than it is in a case where the protective member is not connected to the support and disposed at the end surface of the solid electrolyte layer. For that reason, even when the solid-state battery is repeatedly charged and discharged, the adhesion of the protective member to the electrode body is unlikely to weaken. That is, the protective member is unlikely to peel away from the electrode body. As a result, in the solid-state battery of the first aspect, the occurrence of short circuits is inhibited.
<2> A solid-state battery of a second aspect is the solid-state battery of <1>, wherein:
the electrode body includes a plurality of unit electrode bodies that are laminated along the lamination direction,
each unit electrode body includes the positive electrode current collector, the positive electrode active material layer, the solid electrolyte layer, the negative electrode active material layer, and the negative electrode current collector, and
the protective member is connected to supports and disposed at end surfaces of solid electrolyte layers that are adjacent between two of the unit electrode bodies that are adjacent.

The laminate structure of the “unit electrode bodies” includes a monopolar structure or a bipolar structure.

In the second aspect, the protective member is connected to the supports and disposed at end surfaces of the solid electrolyte layers that are adjacent between two of the unit electrode bodies that are adjacent. That is, the positive electrode active material layers or the negative electrode active material layers disposed between the solid electrolyte layers that are adjacent between two of the unit electrode bodies that are adjacent are easily reliably covered by the protective member. Because of this, the protective member more reliably blocks electrical contact between the positive electrode active material layers and the negative electrode active material layers. In addition, the protective member more reliably blocks electrical contact between the casing of the solid-state battery and at least one of the positive electrode active material layers or the negative electrode active material layers. As a result, in the solid-state battery of the second aspect, the occurrence of short circuits is further inhibited.
<3> A solid-state battery of a third aspect is the solid-state battery of <2>, wherein:
each unit electrode body is configured by laminating the positive electrode current collector, the positive electrode active material layer, the solid electrolyte layer, the negative electrode active material layer, the negative electrode current collector, the negative electrode active material layer, the solid electrolyte layer, the positive electrode active material layer, and the positive electrode current collector in this order along the lamination direction, and
the protective member is connected to supports and disposed at end surfaces of solid electrolyte layers that are adjacent within the unit electrode bodies.

In the third aspect, the laminate structure of the electrode body is a configuration where a plurality of the unit electrode bodies having a monopolar structure are connected in parallel. In the third aspect, the protective member is connected to the supports and disposed at end surfaces of the solid electrolyte layers that are adjacent within the unit electrode bodies. That is, the positive electrode active material layers or the negative electrode active material layers disposed between the solid electrolyte layers that are adjacent within the unit electrode bodies are easily reliably covered by the protective member. Because of this, the protective member more reliably blocks electrical contact between the positive electrode active material layers and the negative electrode active material layers. In addition, the protective member more reliably blocks electrical contact between the casing of the solid-state battery and at least one of the positive electrode active material layers or the negative electrode active material layers. As a result, in the solid-state battery of the third aspect, the occurrence of short circuits is further inhibited.
<4> A solid-state battery of a fourth aspect is the solid-state battery of any one of <1> to <3>, wherein the protective member is disposed covering an end surface of at least one of the positive electrode active material layer or the negative electrode active material layer.

Because of this, the protective member more reliably blocks electrical contact between the positive electrode active material layer and the negative electrode active material layer. In addition, the protective member more reliably blocks electrical contact between the casing of the solid-state battery and at least one of the positive electrode active material layer or the negative electrode active material layer. As a result, in the solid-state battery of the fourth aspect, the occurrence of short circuits is further inhibited.
<5> A solid-state battery of a fifth aspect is the solid-state battery of any one of <1> to <4>, wherein:
the electrode body has:
   a first side surface portion,
   a second side surface portion that opposes the first side surface portion,
   a third side surface portion that interjoins the first side surface portion and the second side surface portion, and
   a fourth side surface portion that interjoins the first side surface portion and the second side surface portion and opposes the third side surface portion,
the current collector tabs project relative to at least one of the third side surface portion or the fourth side surface portion, and
the protective member is disposed covering the first side surface portion and the second side surface portion.

“Side surface portions of the electrode body” refers to surfaces of the electrode body whose normal direction intersects the normal direction (lamination direction) of a main surface of the electrode body. “Main surface” refers to a surface whose normal direction is parallel to the lamination direction.

In the fifth aspect, the protective member is disposed covering the first side surface portion and the second side surface portion. Because of this, the protective member reliably blocks electrical contact between the positive electrode active material layer and the negative electrode active material layer more than in a case where the protective member is not disposed covering the first side surface portion and the second side surface portion. The protective member more reliably blocks electrical contact between both the positive electrode active material layer and the negative electrode active material layer and the casing of the solid-state battery at the first side surface portion and the second side surface portion. As a result, in the solid-state battery of the fifth aspect, the occurrence of short circuits is further inhibited.
<6> A solid-state battery of a sixth aspect is the solid-state battery of any one of <1> to <5>, wherein:
the electrode body has:
   a first side surface portion,
   a second side surface portion that opposes the first side surface portion,
   a third side surface portion that interjoins the first side surface portion and the second side surface portion, and
   a fourth side surface portion that interjoins the first side surface portion and the second side surface portion and opposes the third side surface portion,
the current collector tabs project relative to at least one of the third side surface portion or the fourth side surface portion, and
the protective member is disposed connected to the current collector tabs at the third side surface portion and the fourth side surface portion.

In the sixth aspect, the protective member is disposed connected to the current collector tabs at the third side surface portion and the fourth side surface portion. That is, the positive electrode active material layer or the negative electrode active material layer disposed between the solid electrolyte layer and the current collector tabs is easily reliably covered by the protective member. Because of this, the protective member more reliably blocks electrical contact between the positive electrode active material layer and the negative electrode active material layer. The protective member more reliably blocks electrical contact between the casing of the solid-state battery and at least one of the positive electrode active material layer or the negative electrode active material layer. As a result, in the solid-state battery of the sixth aspect, the occurrence of short circuits is further inhibited.
<7> A solid-state battery of a seventh aspect is the solid-state battery of any one of <1> to <6>, wherein the support is a nonwoven.

A “nonwoven” is a sheet-like structure made from fibers that are bonded or entangled without being woven and refers to a planar fiber assembly in which a predetermined level of structural strength is obtained by a physical method and/or chemical method excluding weaving, knitting, and papermaking (JIS L0222:2022). The fiber assembly has a plurality of pores. The nonwoven includes a resin.

The solid-state battery of the seventh aspect has a battery performance that is more sufficient than it is in a case where the support is not a nonwoven.
<8> A method of manufacturing a solid-state battery of an eighth aspect includes:
preparing an electrode body having a positive electrode current collector, a positive electrode active material layer, a solid electrolyte layer, a negative electrode active material layer, and a negative electrode current collector that are laminated along a lamination direction, the solid electrolyte layer having a support including a plurality of fibers, and the support projecting from an end surface of the solid electrolyte layer; and
forming at the end surface, a protective member that is disposed connected to the support,
wherein a material of the fibers and a material of the protective member are different.

The solid-state battery manufacturing method of the eighth aspect can manufacture a solid-state battery in which the occurrence of short circuits is inhibited.

According to the embodiments of the present disclosure, a solid-state battery in which the occurrence of short circuits is inhibited and a method of manufacturing the solid-state battery are provided.

### BRIEF DESCRIPTION OF THE DRAWINGS

Exemplary embodiments of the present disclosure will be described in detail based on the following figures, wherein:

FIG. 1 is a perspective view of a solid-state battery pertaining to a first embodiment;

FIG. 2 is a front elevation view of an electrode body pertaining to the first embodiment;

FIG. 3 is a cross-sectional view taken along line III-III of FIG. 2;

FIG. 4 is a cross-sectional view taken along line IV-IV of FIG. 2;

FIG. 5 is a front elevation view of the electrode body pertaining to a second embodiment;

FIG. 6 is a cross-sectional view taken along line VI-VI of FIG. 5;

FIG. 7 is a cross-sectional view taken along line VII-VII of FIG. 5; and

FIG. 8 is a cross-sectional view of an example of an electrode body having a laminate structure where a plurality of unit electrode bodies having a bipolar structure are connected in series.

### DETAILED DESCRIPTION

In the present disclosure, a numerical range expressed using “to” means a range that includes the numerical values appearing before and after the “to” as a minimum value and a maximum value, respectively. In numerical ranges that are progressively stated in the present disclosure, the upper limit value or the lower limit value stated in a given numerical range may be replaced with the upper limit value or the lower limit value of another progressively stated numerical range. In the present disclosure, a combination of two or more preferred aspects is a more preferred aspect. In the present disclosure, the term “step” includes not only an independent step but also a step that cannot be clearly distinguished from another step as long as the intended object of that step is achieved.

Embodiments of a solid-state battery and a method of manufacturing the solid-state battery of the present disclosure will now be described below with reference to the drawings. Regarding identical or corresponding parts in the drawings, identical reference signs are assigned thereto, and description thereof will not be repeated.

### (1) First Embodiment

### (1.1) Solid-State Battery

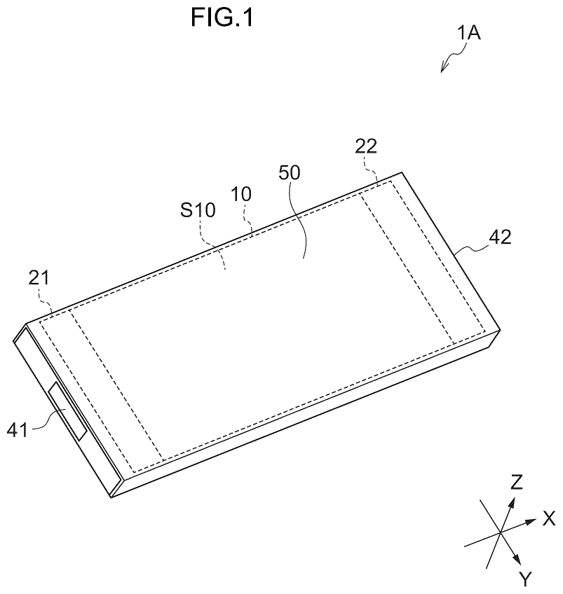

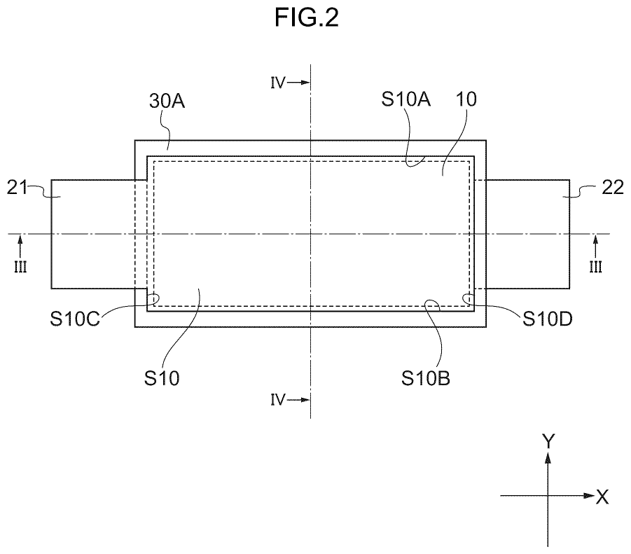

As shown in FIG. 1, a solid-state battery 1A pertaining to a first embodiment includes an electrode body 10, a plurality of positive electrode current collector tabs 21 (an example of current collector tabs), a plurality of negative electrode current collector tabs 22 (an example of current collector tabs), a protective member 30A (see FIG. 2), a positive electrode terminal 41, a negative electrode terminal 42, and a casing 50. The electrode body 10 is a rectangular cuboid.

In the first embodiment, the lengthwise direction of a main surface S10 of the electrode body 10 defines the X-axis direction. The widthwise direction of the main surface S10 of the electrode body 10 defines the Y-axis direction. The thickness direction of the electrode body 10 defines the Z-axis direction. The X-axis, the Y-axis, and the Z-axis are all orthogonal to each other. The Z-axis direction is an example of a lamination direction. It will be noted that these directions are not intended to limit the directions of the solid-state battery of the present disclosure when it is in use.

The positive electrode terminal 41, the plural positive electrode current collector tabs 21, the electrode body 10, the plural negative electrode current collector tabs 22, and the negative electrode terminal 42 are arranged in this order along the X-axis positive direction. The plural positive electrode current collector tabs 21 electrically interconnect the positive electrode terminal 41 and the electrode body 10. The plural negative electrode current collector tabs 22 electrically interconnect the negative electrode terminal 42 and the electrode body 10. The protective member 30A is attached to the side surfaces of the electrode body 10. The casing 50 covers the electrode body 10, the plural positive electrode current collector tabs 21, the plural negative electrode current collector tabs 22, and the protective member 30A. The electrode body 10, the positive electrode current collector tabs 21, the negative electrode current collector tabs 22, and the protective member 30A are sealed by the positive electrode terminal 41, the negative electrode terminal 42, and the casing 50.

### (1.1.1) Electrode Body

The electrode body 10 functions as a power generating element of the solid-state battery 1A.

The electrode body 10 is a rectangular cuboid. As shown in FIG. 2, the electrode body 10 has a first side surface portion S10A, a second side surface portion S10B, a third side surface portion S10C, and a fourth side surface portion S10D. The second side surface portion S10B opposes the first side surface portion S10A in the Y-axis direction. The third side surface portion S10C interjoins the first side surface portion S10A and the second side surface portion S10B. The fourth side surface portion S10D interjoins the first side surface portion S10A and the second side surface portion S10B. The fourth side surface portion S10D opposes the third side surface portion S10C in the X-axis direction.

Each of the first side surface portion S10A, the second side surface portion S10B, the third side surface portion S10C, and the fourth side surface portion S10D may be a surface without steps (i.e., a flat surface) or a surface with steps (i.e., a stepped surface).

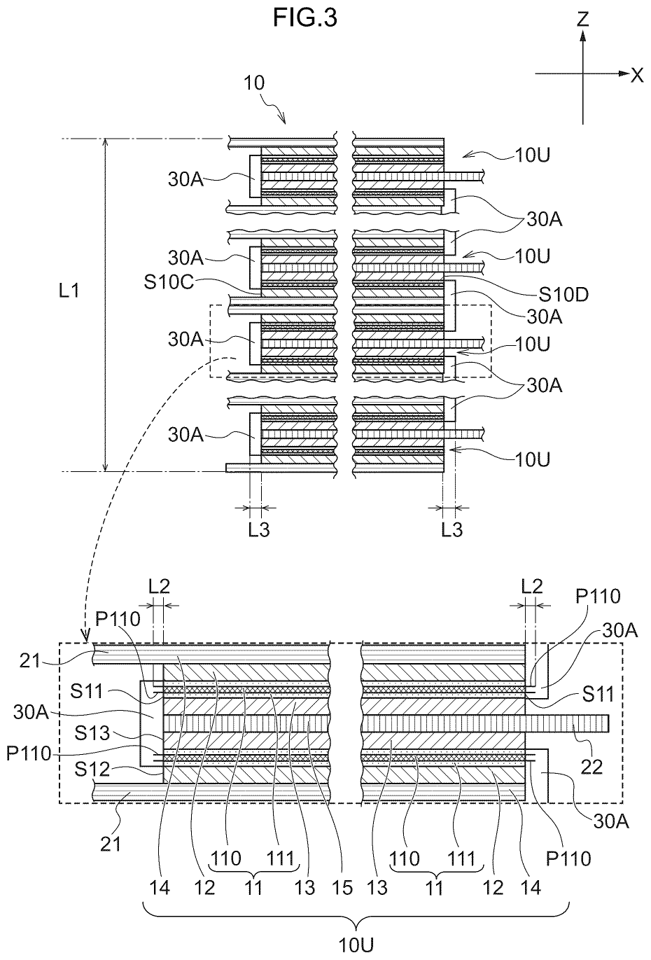

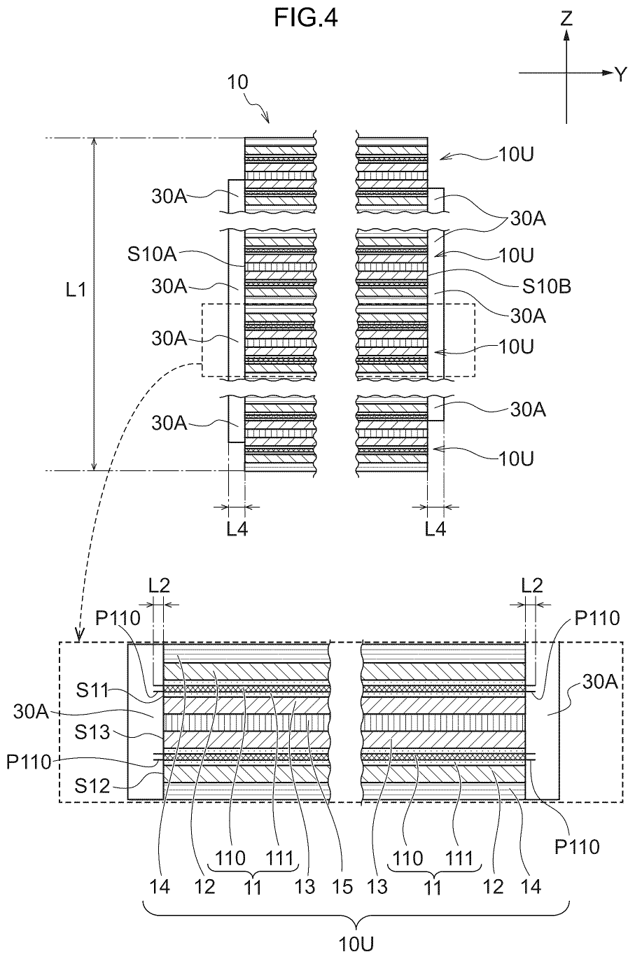

A length L1 (thickness) of the electrode body 10 in the Z-axis direction (see FIG. 3 and FIG. 4) is not particularly limited and may, for example, be 18.5 mm.

As shown in FIG. 3 and FIG. 4, the electrode body 10 includes a plurality of unit electrode bodies 10U. The plural unit electrode bodies 10U are laminated along the Z-axis direction. The plural unit electrode bodies 10U are connected in parallel.

The laminate structure of the unit electrode bodies 10U is a monopolar structure. Specifically, the unit electrode bodies 10U each have two solid electrolyte layers 11, two positive electrode active material layers 12, two negative electrode active material layers 13, two positive electrode current collectors 14, and one negative electrode current collector 15. The positive electrode current collector 14, the positive electrode active material layer 12, the solid electrolyte layer 11, the negative electrode active material layer 13, the negative electrode current collector 15, the negative electrode active material layer 13, the solid electrolyte layer 11, the positive electrode active material layer 12, and the positive electrode current collector 14 are laminated in this order along the Z-axis direction.

### (1.1.1.1) Solid Electrolyte Layers

Each of the solid electrolyte layers 11 includes a support 110 and a solid electrolyte 111. The solid electrolyte 111 is disposed in the support 110. Specifically, the solid electrolyte 111 fills the inside of the support 110. The solid electrolyte 111 covers the support 110. The support 110 includes a plurality of fibers. The plural fibers are different in material from the protective member 30A.

The supports 110 project from end surfaces S11 of the solid electrolyte layers 11. In the first embodiment, as shown in FIG. 3 and FIG. 4, pluralities of single fibers P110 (also called “projecting fibers P110”) project at the end surfaces S11 of the solid electrolyte layers 11. The projecting fibers P110 derive from the fibers included in the supports 110.

The pluralities of projecting fibers P110 may be irregularly or regularly disposed. The number of the projecting fibers P110 is not particularly limited. When the supports 110 are observed from a direction parallel to the end surfaces S11 of the solid electrolyte layers 11 (e.g., the Z-axis direction), the number of the projecting fibers P110 may be 10/mm or more. The shapes of the projecting fibers 110 may extend linearly toward a specific direction or may extend while curving in a specific direction.

A length L2 of the projecting fibers P110 in a direction orthogonal to the end surfaces S11 of the solid electrolyte layers 11 (see FIG. 3 and FIG. 4) is not particularly limited and may be 0.05 mm to 0.5 mm. It will be noted that in FIG. 3, L2 is the length of the projecting fibers P110 in the X-axis direction. In FIG. 4, L2 is the length of the projecting fibers P110 in the Y-axis direction.

The end surfaces S11 from which the pluralities of projecting fibers P110 project may, for example, be sheared surfaces formed by shearing the supports 110 under specific conditions. A shearing tool (e.g., scissors or a round blade) may be used to shear the supports 110.

### (1.1.1.1.1) Supports

The supports 110 hold the solid electrolyte 111. The supports 110 and the solid electrolyte 111 prevent electrical contact between the positive electrode active material layers 12 and the negative electrode active material layers 13.

The supports 110 include a plurality of fibers and may comprise a plurality of fibers. The supports 110 have a plurality of pores. The solid electrolyte 111 fills the plural pores in the supports 110.

The pore size of the supports 110 is not particularly limited and may, from standpoints such as further reducing the battery resistance of the solid-state battery 1A, be 1 μm to 15 μm. The method of measuring the pore size of the supports 110 is the bubble point method (JIS K 3832).

The areal weight of the supports 110 is not particularly limited and may, from standpoints such as further reducing the battery resistance of the solid-state battery 1A, be 0.10 mg/cm² to 0.80 mg/cm². The areal weight of the supports 110 is obtained by cutting out sheets with a certain area from the supports 110 and calculating the mass per unit area of the sheets that have been cut out.

The void fraction of the supports 110 is not particularly limited and may, from standpoints such as further reducing the battery resistance of the solid-state battery 1A, be 30% to 95% or 30% to 70%. “Void fraction” refers to the volume of the voids inside the supports 110 relative to the total volume of the supports 110. The void fraction of the supports 110 is obtained by calculating the volume of the voids from the difference between the actual volume of the supports 110 and the volume calculated from the specific gravity of a material and calculating the ratio of the voids to the actual volume of the supports 110.

The length (thickness) of the supports 110 in the Z-axis direction is not particularly limited and may be 10 μm to 30 μm or 10 μm to 15 μm. The thickness of the supports 110 is measured using a bench micrometer.

Examples of the supports 110 include nonwovens or mesh sheets. The supports 110 are preferably a nonwoven. The supports 110 are preferably configured by a single nonwoven.

“Mesh sheets” refers to woven fabrics that include a plurality of resin fibers and have pores between the resin fibers.

The nonwoven is not particularly limited, and examples thereof include meltblown nonwovens, spunbond nonwovens, carded nonwovens, parallel-laid nonwovens, cross-laid nonwovens, random-laid nonwovens, spunlaid nonwovens, flashspun nonwovens, chemical bonded nonwovens, hydroentangled nonwovens, needle-punched nonwovens, stitch-bonded nonwovens, thermobonded nonwovens, burst fiber nonwovens, tow opening nonwovens, and film-split nonwovens.

Among these, the type of the nonwoven is preferably a meltblown nonwoven. A meltblown nonwoven comprises ultrafine fibers (e.g., fibers having a diameter of 1 μm to 6 μm). For that reason, with a meltblown nonwoven, even if its areal weight is low the number of fibers included in the nonwoven is high. As a result, a nonwoven in which the pore size, the areal weight, and the void fraction are within the above-described ranges is easily obtained.

The nonwoven is configured by fibers. The fiber diameter and the fiber length of the fibers are not particularly limited. The fibers may be filament fibers or staple fibers. The cross-sectional shape of the fibers is not particularly limited, and examples thereof include a circular shape, an oval shape, or an irregular shape.

Examples of materials of the fibers include resins and glass. Examples of the resins include polyester resins (e.g., polyethylene terephthalate (PET)), polyolefin resins (e.g., polyethylene (PE) or polypropylene (PP)), or polyamide resins (e.g., nylon or aramids).

The mesh sheets are configured by fibers. Examples of the fibers of the mesh sheets include the same ones as those that were exemplified as fibers of the nonwovens.

### (1.1.1.1.2) Solid Electrolyte

The solid electrolyte 111 is not particularly limited and may be an aggregate of a plurality of particles. The particle size of the particles is not particularly limited as long as it is a particle size that can penetrate the insides of the pores in the supports 110 and may be 0.05 μm to 3.0 μm. The particle size of the particles is preferably smaller than the thickness of the supports 110. The ratio of the total volume of the solid electrolyte 111 to the total volume of the voids in the supports 110 may be 50 vol % or more, 70 vol % or more, or 90 vol %. The particle size of the particles is obtained by observing the cross-sections of the solid electrolyte layers 11 with a scanning electron microscope (SEM), randomly selecting particles, and measuring the average value of the particle sizes.

The solid electrolyte 111 preferably includes one selected from the group comprising sulfide solid electrolytes, oxide solid electrolytes, and halide solid electrolytes. The solid electrolyte 111 may be a known solid electrolyte.

### (1.1.1.1.3) Binder

The solid electrolyte layers may further include a binder. The binder may be used for binding together the solid electrolyte. The binder may be used for binding the solid electrolyte 111 and the positive electrode active material layers 12 or the negative electrode active material layers 13. Examples of the binder include vinyl halide resins (e.g., polyvinylidene fluoride (PVdF)), rubbers (e.g., acrylate-butadiene rubber (ABR) or styrene-butadiene rubber (SBR)), or polyolefin resins (e.g., polyethylene (PE) or polypropylene (PP)).

### (1.1.1.2) Positive Electrode Active Material Layers

The positive electrode active material layers 12 contain a positive electrode active material. The positive electrode active material layers 12 may contain at least one of a solid electrolyte for a positive electrode, a conductive additive, or a binder as needed.

The positive electrode active material layers 12 preferably include a lithium complex oxide as the positive electrode active material. The lithium complex oxide may contain at least one type selected from the group comprising F, Cl, N, S, Br, or I. Furthermore, the lithium complex oxide may have a crystalline structure belonging to at least one space group selected from the space groups R-3m, Immm, or P63-mmc. Furthermore, the main array of the transition metal, oxygen, and lithium in the lithium complex oxide may have an O2 structure. The positive electrode active material may be a known positive electrode active material.

Examples of the solid electrolyte for a positive electrode include the same ones as those that were exemplified as solid electrolytes included in the solid electrolyte layers.

Examples of the conductive additive include carbon materials (e.g., carbon black, carbon nanotubes, graphite, or carbon fluoride), metal materials (e.g., aluminum powder or conductive whiskers), or conductive polymer materials (e.g., polyaniline, polypyrrole, or polythiophene).

Examples of the binder include the same ones as those that were exemplified as binders included in the solid electrolyte layers.

### (1.1.1.3) Negative Electrode Active Material Layers

The negative electrode active material layers 13 contain a negative electrode active material. The negative electrode active material layers 13 may contain at least one of a solid electrolyte for a negative electrode, a conductive additive, or a binder as needed.

Examples of the negative electrode active material include Li-based active materials (e.g., metallic lithium), carbon-based active materials (e.g., graphite), oxide-based active materials (e.g., lithium titanate), or Si-based active materials (e.g., elemental Si).

Examples of the solid electrolyte for a negative electrode include the same ones as those that were exemplified as solid electrolytes for a positive electrode that can be used in the positive electrode active material layers.

Examples of conductive additives that can be used in the negative electrode active material layers include the same ones as those that were exemplified as conductive additives that can be used in the positive electrode active material layers.

Examples of binders that can be used in the negative electrode active material layers include the same ones that were exemplified as binders that can be used in the positive electrode active material layers.

### (1.1.1.4) Positive Electrode Current Collectors

The positive electrode current collectors 14 collect current from the positive electrode active material layers 12. A material of the positive electrode current collectors is not particularly limited, and examples thereof include stainless steel, aluminum, copper, nickel, iron, titanium, or carbon. The positive electrode current collectors may be aluminum alloy foil or aluminum foil. The aluminum alloy foil and the aluminum foil may be manufactured using powder. The shape of the positive electrode current collectors may be foil-like or mesh-like. The positive electrode current collectors may have a configuration where a buffer layer, an elastic layer, or a positive temperature coefficient (PTC) thermistor layer is disposed on their surfaces.

### (1.1.1.5) Negative Electrode Current Collector

The negative electrode current collector 15 collects current from the negative electrode active material layers 13. A material of the negative electrode current collector is not particularly limited, and examples thereof include stainless steel, aluminum, copper, nickel, iron, titanium, or carbon. The negative electrode current collector may be copper foil. The shape of the negative electrode current collector may be foil-like or mesh-like. The negative electrode current collector may have a configuration where a buffer layer, an elastic layer, or a positive temperature coefficient (PTC) thermistor layer is disposed on its surface.

### (1.1.2) Positive Electrode Current Collector Tabs and Negative Electrode Current Collector Tabs

The positive electrode current collector tabs 21 electrically interconnect the positive electrode current collectors 14 and the positive electrode terminal 41. The positive electrode current collector tabs 21 are connected to the positive electrode current collectors 14. As shown in FIG. 2 and FIG. 3, the positive electrode current collector tabs 21 project in the X-axis negative direction relative to the third side surface portion S10C. Specifically, in the first embodiment, a bundle including the plural positive electrode current collector tabs 21 is electrically connected to the positive electrode terminal 41. The positive electrode current collector tabs 21 are preferably formed continuously from the positive electrode current collectors 14.

The negative electrode current collector tabs 22 electrically interconnect the negative electrode current collectors 15 and the negative electrode terminal 42. The negative electrode current collector tabs 22 are connected to the negative electrode current collectors 15. As shown in FIG. 2 and FIG. 3, the negative electrode current collector tabs 22 project in the X-axis positive direction relative to the fourth side surface portion S10D. Specifically, in the first embodiment, a bundle including the plural negative electrode current collector tabs 22 is electrically connected to the negative electrode terminal 42. The negative electrode current collector tabs 22 are preferably formed continuously from the negative electrode current collectors 15.

A material of the negative electrode current collector tabs and the positive electrode current collector tabs is not particularly limited and may be metal (e.g., aluminum, stainless steel (SUS), or nickel).

### (1.1.3) Protective Member

The protective member 30A blocks electrical contact between the positive electrode active material layers 12 and the negative electrode active material layers 13.

The protective member 30A is connected to the projecting fibers P110 and disposed on the side surfaces (i.e., the side surface portions S10A to S10D) of the electrode body 10. As shown in FIG. 3, the protective member 30A is connected to the projecting fibers P110 and disposed at the end surfaces S11 of the solid electrolyte layers 11 that are adjacent within the unit electrode bodies 10U and between two of the unit electrode bodies 10U that are adjacent at the third side surface portion S10C and the fourth side surface portion S10D. As shown in FIG. 4, the protective member 30A is disposed covering end surfaces S12 of the positive electrode active material layers 12 and end surfaces S13 of the negative electrode active material layers 13 at the first side surface portion S10A and the second side surface portion S10B. As shown in FIG. 3, the protective member 30A is disposed covering the end surfaces S13 of the negative electrode active material layers 13 at the third side surface portion S10C. The protective member 30A is disposed covering the end surfaces S12 of the positive electrode active material layers 12 at the fourth side surface portion S10D.

In the first embodiment, the protective member 30A is not disposed connected to each of the positive electrode current collector tabs 21 and the negative electrode current collector tabs 22 at the third side surface portion S10C and the fourth side surface portion S10D.

A length S3 of the protective member 30A in the X-axis direction at the third side surface portion S10C and the fourth side surface portion S10D (see FIG. 3) is not particularly limited and may be 0.02 mm to 0.20 mm. A length L4 of the protective member 30A in the Y-axis direction at the first side surface portion S10A and the second side surface portion S10B (see FIG. 4) is not particularly limited and may be 0.02 mm to 1.00 mm.

The protective member 30A may be a solidified product of a resin composition. The resin composition is different from a material of the fibers included in the supports 110. The resin composition may be any known resin composition (e.g., a thermoplastic resin composition, a thermosetting resin composition, or a photocurable resin composition) as long as it is a resin composition in a solid state at the operating temperature of the solid-state battery 1A (e.g., 120° C. or lower). The resin composition includes a known resin (e.g., a thermoplastic resin, a thermosetting resin, or a photocurable resin). The resin composition may further include a polymerization initiator or a curing agent as needed.

The surface energy of a material (e.g., the resin composition) of the protective member 30A is preferably greater than the surface energy of a material of the supports 110. Because of this, the unsolidified product of the protective member 30A is less likely to be repelled by the supports 110 (specifically, the projecting fibers P110) than in a case where the surface energy of a material of the protective member 30A is smaller than the surface energy of a material of the supports 110. As a result, the protective member 30A more strongly adheres to the projecting fibers P110.

“Surface energy” refers to Gibbs free energy. Surface energy can be calculated from surface tension. Surface tension is the Gibbs free energy per unit area at the surface of a material.

### (1.1.4) Negative Electrode Terminal and Positive Electrode Terminal

The positive electrode terminal 41 and the negative electrode terminal 42 are used to conduct electricity generated by the electrode body to the outside of the solid-state battery 1A. The positive electrode terminal 41 and the negative electrode terminal 42 are rectangular cuboids. Examples of a material of the positive electrode terminal 41 and the negative electrode terminal 42 include metal (e.g., aluminum, stainless steel (SUS), or nickel).

### (1.1.5) Casing

The casing 50 covers the electrode body 10 and, together with the positive electrode terminal 41 and the negative electrode terminal 42, seals the electrode body 10. In the first embodiment, the casing 50 is a metal container. The casing 50 is a rectangular cuboid (i.e., prismatic). The casing 50 has a first wall that opposes the third side surface portion S10C of the electrode body 10 and a second wall that opposes the fourth side surface portion S10D of the electrode body 10. The first wall has one through hole. As shown in FIG. 1, the positive electrode terminal 41 is exposed through the through hole in the first wall. The second wall has one through hole that is the same as the one in the first wall. The negative electrode terminal 42 is exposed through the through hole in the second wall. A material of the casing 50 is metal (e.g., aluminum, copper, stainless steel (SUS), or nickel). The casing 50 may have an electrical insulator on the surfaces (inner peripheral walls) that oppose the electrode body 10 to prevent electrical connection with the electrode body 10. The electrical insulator may be a layer-like object or a bag.

### (1.1.6) Applications

Examples of applications of the solid-state battery 1A include being a power source for electrical devices (e.g., vehicles, electronic devices, or electricity storages). Examples of vehicles include four-wheeled electric vehicles, two-wheeled electric vehicles, gasoline automobiles, or diesel automobiles. Examples of four-wheeled electric vehicles include battery electric vehicles (BEV), plug-in hybrid electric vehicles (PHEV), or hybrid electric vehicles (HEV). Examples of two-wheeled electric vehicles include electric bikes or pedal-assist electric bicycles. Examples of electronic devices include handheld devices (e.g., smartphones, tablet computers, or audio players), portable devices (e.g., notebook computers or compact disc (CD) players), or movable devices (e.g., electric tools or professional video cameras). Among these, the solid-state battery 1A is preferably applied as a power source for driving a hybrid electric vehicle, a plug-in hybrid electric vehicle, or a battery electric vehicle.

### (1.2) Solid-State Battery Manufacturing Method

The solid-state battery manufacturing method of the first embodiment is a method of manufacturing the solid-state battery 1A. The manufacturing method includes a preparation step, a current collector tab connection step, a lamination step, a protective member formation step, a connection step, and a sealing step. The preparation step, the current collector tab connection step, the lamination step, the protective member formation step, the connection step, and the sealing step are carried out in this order.

### (1.2.1) Preparation Step

In the preparation step, an electrode body 10 to which the positive electrode current collector tabs 21 and the negative electrode current collector tabs 22 are connected is prepared. The solid electrolyte layers 11 of the electrode body 10 have the supports 110 including a plurality of fibers. The supports 110 project from the end surfaces S11 of the solid electrolyte layers 11. In the first embodiment, as shown in FIG. 3 and FIG. 4, the pluralities of projecting fibers P110 project at the end surfaces S11 of the solid electrolyte layers 11.

The method of preparing the electrode body 10 is not particularly limited, and examples thereof include a first method or a second method.

### (1.2.1.1) First Method

The first method includes a solid electrolyte sheet preparation step and a unit electrode body formation step. The solid electrolyte sheet preparation step and the unit electrode body formation step are carried out in this order.

In the solid electrolyte sheet preparation step, solid electrolyte sheets are prepared. The solid electrolyte sheets are the raw material of the solid electrolyte layers 11. The end surfaces of the solid electrolyte sheets correspond to the end surfaces S11 of the solid electrolyte layers 11.

The method of preparing the solid electrolyte sheets may, for example, be a method where support sheets that are the raw material of the supports 110 are sheared, so that the pluralities of projecting fibers P110 are formed on the sheared surfaces, to obtain the supports 110 and a solid electrolyte paste is applied to the entireties of the obtained supports 110 and dried to form the solid electrolyte sheets. A shearing tool (e.g., scissors) is used to shear the support sheets. The solid electrolyte paste includes the solid electrolyte 111 and a known dispersion medium and may include a binder as needed. The application method, the drying method, and the placement method may be any known methods.

In the unit electrode body formation step, the positive electrode current collector 14, the positive electrode active material layer 12, the solid electrolyte sheet, the negative electrode active material layer 13, the negative electrode current collector 15, the negative electrode active material layer 13, the solid electrolyte sheet, the positive electrode active material layer 12, and the positive electrode current collector 14 are laminated in this order along the Z-axis direction to form the unit electrode body 10U.

The method of forming the positive electrode current collectors 14, the positive electrode active material layers 12, the negative electrode active material layers 13, and the negative electrode current collector 15 is not particularly limited and may be any known method. The lamination method is not particularly limited and may be any known method.

### (1.2.1.2) Second Method

The second method includes a unit electrode body sheet preparation step and a cutting step. The unit electrode body sheet preparation step and the cutting step are carried out in this order.

In the unit electrode body sheet preparation step, unit electrode body sheets are prepared. The unit electrode body sheets are the same as the unit electrode bodies 10U except that they are larger in size than the unit electrode bodies 10U.

The method of preparing the unit electrode body sheets may be a known method.

In the cutting step, the unit electrode body sheets are sheared, so that the pluralities of projecting fibers P110 are formed at the end surfaces S11 of the solid electrolyte layers 11 configuring the sheared surfaces, to form the unit electrode bodies 10U. A shearing tool (e.g., a round blade) is used to shear the unit electrode body sheets.

### (1.2.2) Current Collector Tab Connection Step

In the current collector tab connection step, the positive electrode current collector tabs 21 are connected to the positive electrode current collectors 14 of the unit electrode bodies 10U, and the negative electrode current collector tabs 22 are connected to the negative electrode current collectors 15 of the unit electrode bodies 10U. Because of this, the unit electrode bodies 10U to which the positive electrode current collector tabs 21 and the negative electrode current collector tabs 22 are connected (hereinafter also called “the unit electrode bodies with the current collector tabs”) are obtained.

The method of connecting the positive electrode current collector tabs 21 and the negative electrode current collector tabs 22 may be any known method.

### (1.2.3) Lamination Step

In the lamination step, a plurality of the unit electrode bodies with the current collector tabs are laminated along the Z-axis direction, and the electrode body 10 to which the positive electrode current collector tabs 21 and the negative electrode current collector tabs 22 are connected (hereinafter also called “the electrode body with the current collector tabs”) is obtained.

The lamination method is not particularly limited and may be any known method.

### (1.2.4) Protective Member Formation Step

In the protective member formation step, the protective member 30A that is disposed on the side surfaces of the electrode body with the current collector tabs (an example of an electrode body) and connected to the projecting fibers P110 is formed. Because of this, an electrode body with the current collector tabs to which the protective member 30A is attached (hereinafter also called “the electrode body with the protective member”) is obtained.

The method of forming the protective member 30A is not particularly limited. For example, the unsolidified product of the resin composition may be applied, and the applied product may be solidified to form a solidified resin product. The application method may be any known method. The solidification method is appropriately selected in accordance with the type of the resin composition for example. In a case where the resin composition is a thermoplastic resin composition or a thermosetting resin composition, the applied product in a molten state of the resin composition may be solidified by cooling. The cooling method is not particularly limited, and examples thereof include a method where the applied material is left at room temperature (25° C.) or a method where cooling air is blown onto the applied product. In a case where the resin composition is a photocurable resin composition, the applied product of the resin composition may be solidified by irradiation with active energy rays (e.g., visible light, ultraviolet light, X-rays, or an electron beam).

### (1.2.5) Connection Step

In the connection step, the plural positive electrode current collector tabs 21 of the electrode body with the protective member are connected to the positive electrode terminal 41, and the plural negative electrode current collector tabs 22 of the electrode body with the protective member are connected to the negative electrode terminal 42.

The connection method is not particularly limited and may be any known method.

### (1.2.6) Sealing Step

In the sealing step, the electrode body 10 with the protective member to which the positive electrode terminal 41 and the negative electrode terminal 42 have been connected is sealed in the casing 50. Because of this, the solid-state battery 1A is obtained.

The sealing method is not particularly limited and may be any known method.

### (1.3) Action and Effects

The action and effects of the solid-state battery 1A will now be specifically described below with reference to the drawings.

As has been described with reference to FIG. 1 to FIG. 4, the solid-state battery 1A includes the electrode body 10, the positive electrode current collector tabs 21, the negative electrode current collector tabs 22, and the protective member 30A. The electrode body 10 has the positive electrode current collectors 14, the positive electrode active material layers 12, the solid electrolyte layers 11, the negative electrode active material layers 13, and the negative electrode current collectors 15 that are laminated along the Z-axis direction. The solid electrolyte layers 11 have the supports 110 including the plurality of fibers that are different in material from the protective member 30A. The supports 110 project from the end surfaces S11 of the solid electrolyte layers 11. The protective member 30A is connected to the supports 110 (i.e., the projecting fibers P110) and disposed at the end surfaces S11 of the solid electrolyte layers 11.

Because of this, the area in which the protective member 30A contacts the electrode body 10 is greater than it is in a case where the protective member 30A is not connected to the supports 110 (i.e., the projecting fibers P110) and disposed at the end surfaces S11 of the solid electrolyte layers 11. For that reason, even when the solid-state battery 1A is repeatedly charged and discharged, the adhesion of the protective member 30A to the electrode body 10 is unlikely to weaken. That is, the protective member 30A is unlikely to peel away from the electrode body 10. As a result, in the solid-state battery 1A, the occurrence of short circuits is inhibited.

As has been described with reference to FIG. 1 to FIG. 4, the electrode body 10 includes a plurality of the unit electrode bodies 10U that are laminated along the Z-axis direction. Each of the unit electrode bodies 10U includes the positive electrode current collectors 14, the positive electrode active material layers 12, the solid electrolyte layers 11, the negative electrode active material layers 13, and the negative electrode current collector 15. The protective member 30A is connected to the supports 110 (i.e., the projecting fibers P110) and disposed at the end surfaces S11 of the solid electrolyte layers 11 that are adjacent between two of the unit electrode bodies 10U that are adjacent.

That is, the positive electrode active material layers 12 or the negative electrode active material layers 13 disposed between the solid electrolyte layers 11 that are adjacent between two of the unit electrode bodies 10U that are adjacent are easily reliably covered by the protective member 30A. Because of this, the protective member 30A more reliably blocks electrical contact between the positive electrode active material layers 12 and the negative electrode active material layers 13. In addition, the protective member 30A more reliably blocks electrical contact between the casing 50 and at least one of the positive electrode active material layers 12 or the negative electrode active material layers 13. As a result, in the solid-state battery 1A, the occurrence of short circuits is further inhibited.

As has been described with reference to FIG. 1 to FIG. 4, each of the unit electrode bodies 10U is configured by laminating the positive electrode current collector 14, the positive electrode active material layer 12, the solid electrolyte layer 11, the negative electrode active material layer 13, the negative electrode current collector 15, the negative electrode active material layer 13, the solid electrolyte layer 11, the positive electrode active material layer 12, and the positive electrode current collector 14 in this order along the Z-axis direction. The protective member 30A is connected to the supports 110 and disposed at the end surfaces S11 of the solid electrolyte layers 11 that are adjacent within the unit electrode bodies 10U.

That is, the positive electrode active material layers 12 or the negative electrode active material layers 13 disposed between the solid electrolyte layers 11 that are adjacent within the unit electrode bodies 10U are easily reliably covered by the protective member 30A. Because of this, the protective member 30A more reliably blocks electrical contact between the positive electrode active material layers 12 and the negative electrode active material layers 13. In addition, the protective member 30A more reliably blocks electrical contact between the casing 50 and at least one of the positive electrode active material layers 12 or the negative electrode active material layers 13. As a result, in the solid-state battery 1A, the occurrence of short circuits is further inhibited.

As has been described with reference to FIG. 1 to FIG. 4, the protective member 30A is disposed covering at least one of the end surfaces S12 of the positive electrode active material layers 12 or the end surfaces S13 of the negative electrode active material layers 13.

Because of this, the protective member 30A more reliably blocks electrical contact between the positive electrode active material layers 12 and the negative electrode active material layers 13. In addition, the protective member 30A more reliably blocks electrical contact between the casing 50 and at least one of the positive electrode active material layers 12 or the negative electrode active material layers 13. As a result, in the solid-state battery 1A, the occurrence of short circuits is further inhibited.

As has been described with reference to FIG. 1 to FIG. 4, the supports 110 are preferably a nonwoven.

As a result, the solid-state battery 1A has a battery performance that is more sufficient than it is in a case where the supports 110 do not comprise a nonwoven.

As has been described with reference to FIG. 1 to FIG. 4, the manufacturing method of the first embodiment has the preparation step and the protective member formation step.

The solid-state battery manufacturing method of the first embodiment can manufacture the solid-state battery 1A in which the occurrence of short circuits is inhibited.

### (2) Second Embodiment

### (2.1) Solid-State Battery

A solid-state battery 1B pertaining to a second embodiment is the same as the solid-state battery 1A pertaining to the first embodiment except that the disposition of the protective member is different.

The solid-state battery 1B includes an electrode body 10, a plurality of positive electrode current collector tabs 21, a plurality of negative electrode current collector tabs 22, a protective member 30B, a positive electrode terminal 41, a negative electrode terminal 42, and a casing 50.

The protective member 30B is the same as the protective member 30A except that its disposition is different.

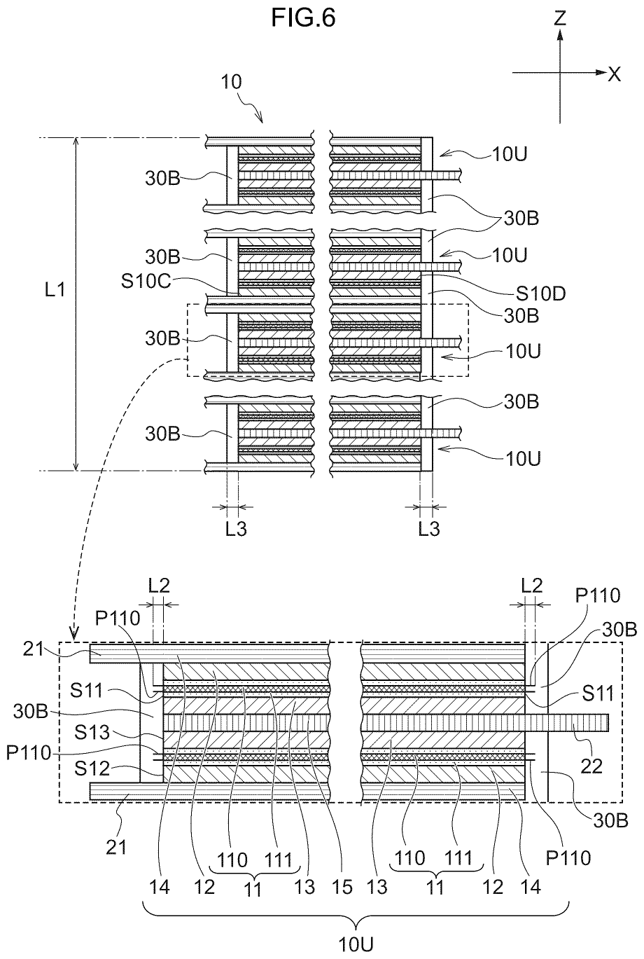

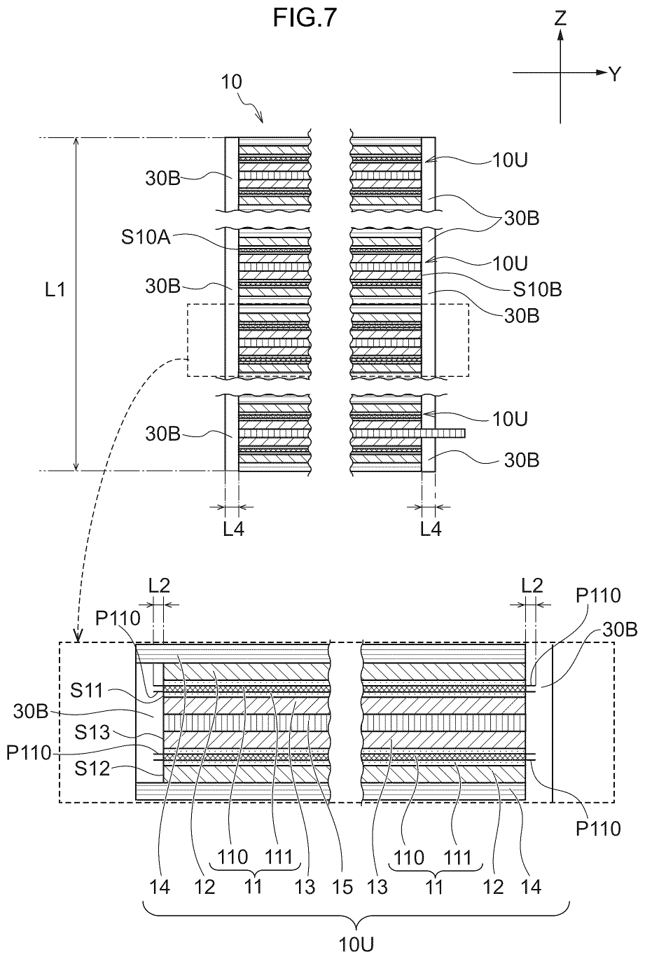

The protective member 30B is connected to the supports 110 (the projecting fibers P110) and disposed at the end surfaces S11 of the solid electrolyte layers 11. As shown in FIG. 6, the protective member 30B is connected to the supports 110 (the projecting fibers P110) and disposed at the end surfaces S11 of the solid electrolyte layers 11 that are adjacent within the unit electrode bodies 10U and between two of the unit electrode bodies 10U that are adjacent. As shown in FIG. 7, the protective member 30B is disposed covering the first side surface portion S10A and the second side surface portion S10B. As shown in FIG. 6, the protective member 30B is disposed connected to the positive electrode current collector tabs 21 and the negative electrode current collector tabs 22 at the third side surface portion S10C and the fourth side surface portion S10D. As shown in FIG. 6 and FIG. 7, the protective member 30B is disposed covering the end surfaces S12 of the positive electrode active material layers 12 and the end surfaces S13 of the negative electrode active material layers 13 at the first side surface portion S10A, the second side surface portion S10B, the third side surface portion S10C, and the fourth side surface portion S10D.

### (2.2) Solid-State Battery Manufacturing Method

The solid-state battery manufacturing method of the second embodiment is a method of manufacturing the solid-state battery 1B. The manufacturing method includes a preparation step, a current collector tab connection step, a lamination step, a protective member formation step, a connection step, and a sealing step. The preparation step, the current collector tab connection step, the lamination step, the protective member formation step, the connection step, and the sealing step are carried out in this order.

The solid-state battery manufacturing method of the second embodiment is the same as the solid-state battery manufacturing method of the first embodiment except that, in the protective member formation step, the positions where the protective member 30B is disposed are different.

### (2.3) Action and Effects

The action and effects of the solid-state battery 1B will now be specifically described below with reference to the drawings.

The solid-state battery 1B is the same as the solid-state battery 1A except that the protective member 30A is changed to the protective member 30B. For that reason, the solid-state battery 1B achieves the same action and effects as those of the solid-state battery 1A.

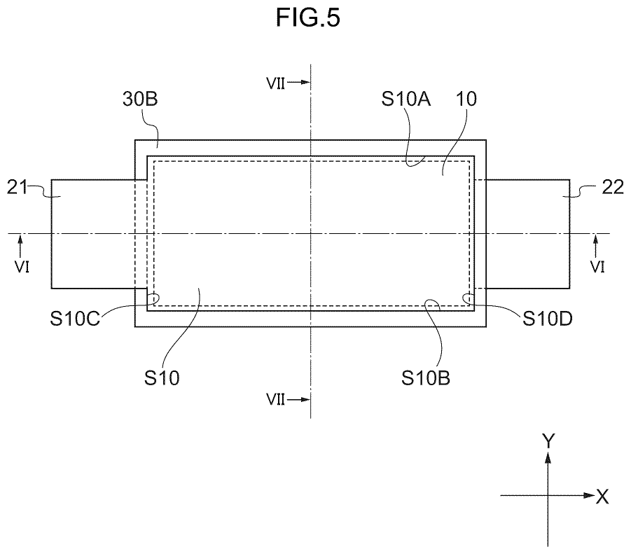

As has been described with reference to FIG. 5 to FIG. 7, the protective member 30B is disposed covering the first side surface portion S10A and the second side surface portion S10B.

Because of this, the protective member 30B reliably blocks electrical contact between the positive electrode active material layers 12 and the negative electrode active material layers 13 more than in a case where the protective member 30B is not disposed covering the first side surface portion S10A and the second side surface portion S10B. The protective member 30B more reliably blocks electrical contact between both the positive electrode active material layers 12 and the negative electrode active material layers 13 and the casing 50 at the first side surface portion S10A and the second side surface portion S10B. As a result, in the solid-state battery 1B, the occurrence of short circuits is further inhibited.

As has been described with reference to FIG. 5 to FIG. 7, the protective member 30B is disposed connected to the positive electrode current collector tabs 21 at the third side surface portion S10C. The protective member 30B is disposed connected to the negative electrode current collector tabs 22 at the fourth side surface portion S10D.

That is, the positive electrode active material layers 12 disposed between the solid electrolyte layers 11 and the positive electrode current collector tabs 21 are easily reliably covered by the protective member 30B. The negative electrode active material layers 13 disposed between the solid electrolyte layers 11 and the negative electrode current collector tabs 22 are easily reliably covered by the protective member 30B. Because of this, the protective member 30B more reliably blocks electrical contact between the positive electrode active material layers 12 and the negative electrode active material layers 13. The protective member 30B more reliably blocks electrical contact between the casing 50 and at least one of the positive electrode active material layers 12 or the negative electrode active material layers 13. As a result, in the solid-state battery 1B, the occurrence of short circuits is further inhibited.

As has been described with reference to FIG. 5 to FIG. 7, the manufacturing method of the second embodiment has the preparation step and the protective member formation step.

The solid-state battery manufacturing method of the second embodiment can manufacture the solid-state battery 1B in which the occurrence of short circuits is inhibited.

### (4) Example Modifications

In the first embodiment and the second embodiment, the pluralities of projecting fibers P110 project at the end surfaces S11 of the solid electrolyte layers 11, but the present disclosure is not limited to this. Fiber assemblies (e.g., parts of nonwovens or parts of mesh sheets) may also project at the end surfaces S11 of the solid electrolyte layers 11.

In the first embodiment and the second embodiment, the electrode body 10 includes a plurality of the unit electrode bodies 10U, but the present disclosure is not limited to this. The electrode body 10 may include one unit electrode body 10U.

In the first embodiment and the second embodiment, each of the unit electrode bodies 10U is configured by laminating the positive electrode current collector 14, the positive electrode active material layer 12, the solid electrolyte layer 11, the negative electrode active material layer 13, the negative electrode current collector 15, the negative electrode active material layer 13, the solid electrolyte layer 11, the positive electrode active material layer 12, and the positive electrode current collector 14 in this order along the Z-axis direction, but the present disclosure is not limited to this. Each of the unit electrode bodies 10U may also be configured by laminating the positive electrode current collector 14, the positive electrode active material layer 12, the solid electrolyte layer 11, the negative electrode active material layer 13, and the negative electrode current collector 15 in this order along the Z-axis direction. Each of the unit electrode bodies 10U may also be configured by laminating the negative electrode current collector 15, the negative electrode active material layer 13, the solid electrolyte layer 11, the positive electrode active material layer 12, the positive electrode current collector 14, the positive electrode active material layer 12, the solid electrolyte layer 11, the negative electrode active material layer 13, and the negative electrode current collector 15 in this order along the Z-axis direction. Each of the unit electrode bodies 10U may further include an insulating layer on the surface of at least one of the positive electrode current collectors 14 on the opposite side of the positive electrode active material layer 12 side.

In the first embodiment, the protective members 30A, 30B are disposed connected to the projecting fibers P110 of the solid electrolyte layers 11 that are adjacent within the unit electrode bodies 10U and between two of the unit electrode bodies 10U that are adjacent, but the present disclosure is not limited to this. In the present disclosure, the protective members 30A, 30B may be disposed connected to the projecting fibers P110 of the solid electrolyte layers 11 that are adjacent in one of within the unit electrode bodies 10U and between two of the unit electrode bodies 10U that are adjacent. The protective members 30A, 30B may also not be disposed connected to the projecting fibers P110 of the solid electrolyte layers 11 that are adjacent within the unit electrode bodies 10U and between two of the unit electrode bodies 10U that are adjacent.

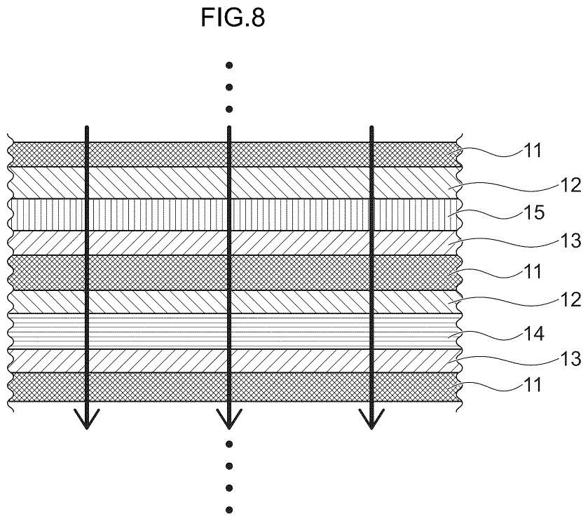

In the first embodiment and the second embodiment, the laminate structure of the electrode body 10 is a configuration where a plurality of the unit electrode bodies 10U having a monopolar structure are connected in parallel, but the present disclosure is not limited to this. The laminate structure of the electrode body may also be a configuration where a plurality of unit electrode bodies having a monopolar structure are connected in series (hereinafter also called a “monopolar series configuration”). In a monopolar series configuration, the electrode body has a conductor that electrically interconnects the positive electrode current collectors 14 and the negative electrode current collectors 15 and does not have bundles including the plural positive electrode current collector tabs 21 or the plural negative electrode current collector tabs 22. The laminate structure of the electrode body 10 may also be a configuration where a plurality of unit electrode bodies having a bipolar structure are connected in series. FIG. 8 shows an example of a configuration where a plurality of unit electrode bodies having a bipolar structure are connected in series.

In the first embodiment and the second embodiment, the casing 50 is a prismatic metal container, but the present disclosure is not limited to this. The casing 50 may also be a container configured by at least one laminate film or may also be a cylindrical metal container.

In the first embodiment and the second embodiment, the positive electrode current collectors 14 and the positive electrode current collector tabs 21 are separate bodies, and the negative electrode current collectors 15 and the negative electrode current collector tabs 22 are separate bodies, but the present disclosure is not limited to this. The positive electrode current collectors 14 and the positive electrode current collector tabs 21 may also be the same bodies. The negative electrode current collectors 15 and the negative electrode current collector tabs 22 may also be the same bodies.

What is claimed is:

1. A solid-state battery comprising an electrode body, current collector tabs that are connected to the electrode body, and a protective member, wherein:
the electrode body has a positive electrode current collector, a positive electrode active material layer, a solid electrolyte layer, a negative electrode active material layer, and a negative electrode current collector that are laminated along a lamination direction,
the solid electrolyte layer has a support including a plurality of fibers that are different in material from the protective member,
the support projects from an end surface of the solid electrolyte layer, and
the protective member is connected to the support and disposed at the end surface.

2. The solid-state battery of claim 1, wherein:
the electrode body includes a plurality of unit electrode bodies that are laminated along the lamination direction,
each unit electrode body includes the positive electrode current collector, the positive electrode active material layer, the solid electrolyte layer, the negative electrode active material layer, and the negative electrode current collector, and
the protective member is connected to supports and disposed at end surfaces of solid electrolyte layers that are adjacent between two of the unit electrode bodies that are adjacent.

3. The solid-state battery of claim 2, wherein:
each unit electrode body is configured by laminating the positive electrode current collector, the positive electrode active material layer, the solid electrolyte layer, the negative electrode active material layer, the negative electrode current collector, the negative electrode active material layer, the solid electrolyte layer, the positive electrode active material layer, and the positive electrode current collector in this order along the lamination direction, and
the protective member is connected to supports and disposed at end surfaces of solid electrolyte layers that are adjacent within the unit electrode bodies.

4. The solid-state battery of claim 1, wherein the protective member is disposed covering an end surface of at least one of the positive electrode active material layer or the negative electrode active material layer.

5. The solid-state battery of claim 1, wherein:
the electrode body has:
a first side surface portion,
a second side surface portion that opposes the first side surface portion,
a third side surface portion that interjoins the first side surface portion and the second side surface portion, and
a fourth side surface portion that interjoins the first side surface portion and the second side surface portion and opposes the third side surface portion,
the current collector tabs project relative to at least one of the third side surface portion or the fourth side surface portion, and
the protective member is disposed covering the first side surface portion and the second side surface portion.

6. The solid-state battery of claim 1, wherein:
the electrode body has:
a first side surface portion,
a second side surface portion that opposes the first side surface portion,
a third side surface portion that interjoins the first side surface portion and the second side surface portion, and
a fourth side surface portion that interjoins the first side surface portion and the second side surface portion and opposes the third side surface portion,
the current collector tabs project relative to at least one of the third side surface portion or the fourth side surface portion, and
the protective member is disposed connected to the current collector tabs at the third side surface portion and the fourth side surface portion.

7. The solid-state battery of claim 1, wherein the support is a nonwoven.

8. A method of manufacturing a solid-state battery comprising:
preparing an electrode body having a positive electrode current collector, a positive electrode active material layer, a solid electrolyte layer, a negative electrode active material layer, and a negative electrode current collector that are laminated along a lamination direction, the solid electrolyte layer having a support including a plurality of fibers, and the support projecting from an end surface of the solid electrolyte layer; and
forming, at the end surface, a protective member that is disposed connected to the support,
wherein a material of the fibers and a material of the protective member are different.
